(19) United States
(12) Patent Application Publication
(10) Pub. No.: US 2018/0146300 A1
(43) Pub. Date: May 24, 2018

(54) MICRO-SILICON MICROPHONE AND FABRICATION METHOD THEREOF

(71) Applicant: MEMSensing Microsystems (Suzhou, China) Co., Ltd., Suzhou (CN)

(72) Inventors: Kai SUN, Suzhou (CN); Wei HU, Suzhou (CN); Gang LI, Suzhou (CN)

(21) Appl. No.: 15/622,876

(22) Filed: Jun. 14, 2017

Related U.S. Application Data
(63) Continuation of application No. PCT/CN2017/081397, filed on Apr. 21, 2017.

(30) Foreign Application Priority Data
Nov. 22, 2016 (CN) 201611032043.3

(51) Int. Cl. H04R 19/04; H04R 19/00; H04R 31/00; H04R 7/06

(52) U.S. Cl. CPC H04R 19/04; H04R 19/005; H04R 2307/025; H04R 7/06; H04R 31/003

(57) ABSTRACT

A micro-silicon microphone and a fabrication method thereof in the preset invention are to solve the technical problem that stress of the micro-silicon microphone influences sensitivity. The micro-silicon microphone in the present invention comprises a silicon substrate, an insulation layer and a vibration film layer sequentially disposed on the silicon substrate. The vibration film comprises vibration beams and a vibration film, the vibration beams are uniformly arranged around a periphery of the vibration film, a first end of the vibration beam is fixed on the periphery of the vibration film and a second end of the vibration beam is fixed on a support structure.

### CROSS REFERENCE OF RELATED APPLICATION

This application is a continuation of International Application No. PCT/CN2017/081397, filed on Apr. 21, 2017, which claims priority to Chinese Patent Application No. 201611032043.3, filed on Nov. 22, 2016. The disclosures of the aforementioned applications are hereby incorporated by reference in their entireties.

### TECHNICAL FIELD

The present disclosure relates to a microphone and a fabrication method thereof, and specifically relates to a micro-silicon microphone and a fabrication method thereof.

### BACKGROUND

A microphone is a transducer that converts a sound signal into an electric signal. Electret capacitance microphones (ECMs) have been widely applied in different fields. However, permanent electric charges in a sensitive film of a traditional ECM may leak out under a high temperature, hence leading to failure of the ECM. In an automatic surface mounting process, an apparatus is usually subject to a welding temperature as high as 260° C., which may make the ECM lose advantages in the field of consumer-purposed electronic products that are massively produced in automation.

In a micro-silicon microphone which is fabricated by employing micro electro mechanical system (MEMS) technique, a bias voltage is directly applied to the microphone by an external power source, therefore permanent charges do not have to be stored in a sensitive film, so that the risk of permanent charges loss at a high temperature does not exist. The micro-silicon microphone, which has the advantage of bearing high temperature in a surface mounting process, is rapidly becoming a substitute of the ECM products. Due to the characteristic of high output impedance, the capacitance-type micro-silicon microphone is largely influenced by environmental interference noises and parasite capacitance, so a monolithic integration mode needs to be employed for a micro-silicon microphone.

One major problem encountered in fabricating a micro-silicon microphone is control of vibration film stress. Deposition is usually used for preparing a thin film in the prior art, and large residual stress, which usually includes mismatch stress and intrinsic stress, will exist in the vibration film obtained by deposition. The residual stress can seriously influence performance of a micro-silicon microphone and even make it fail. Large residual tensile stress may remarkably reduce mechanical sensitivity of a vibration film. Since the mechanical sensitivity of the vibration film is in proportion to sensitivity, which is a key index, of a micro-silicon microphone, so large residual stress may reduce sensitivity of the microphone. Additionally, large residual press stress may cause bending of a vibration film, which can make the microphone fail to operate. In order to increase sensitivity of a microphone, the preparation method such as deposition may be adjusted, or some additional processes such as annealing may be employed to reduce residual stress of a vibration film. However, this method is not effective in reducing residual stress, the repeatability is not favorable and implementation is comparatively complex too.

Therefore, how to solve the problem of residual stress of a vibration film existing in the prior art and achieve fabrication of standard IC and MEMS apparatus on a same substrate to maintain sensitivity of a microphone is already becoming a technical subject to be urgently solved by those in the art.

### SUMMARY

In view of the above, an embodiment of the present invention provides a micro-silicon microphone and a fabrication method thereof, with the purpose of solving the technical problem that the sensitivity of a micro-silicon microphone is reduced due to influences of stress.

A micro-silicon microphone in the present invention comprises a silicon substrate, an insulation layer and a vibration film layer disposed on the silicon substrate, the vibration film layer comprises vibration beams and a vibration film, the vibration beams are uniformly arranged around a periphery of the vibration film, a first end of the vibration beam is fixed at the periphery of the vibration film and a second end of the vibration beam is fixed on a support structure.

In an embodiment, the vibration beams are uniformly arranged around the periphery of the vibration film and connected with the periphery of the vibration film in a perpendicular manner, the first end of the vibration beam extends to the periphery of the vibration film and is smoothly connected with the surface of the vibration film.

In an embodiment, the vibration beam comprises a first vibration beam and a second vibration beam mirroring the first vibration beam, the first vibration beam and the second vibration beam are provided as groups and the groups are uniformly arranged around the periphery of the vibration beam.

In an embodiment, the vibration beam comprises a bend.

In an embodiment, the first vibration beam has a L-type bend, which comprises two crossed bar-type supports, one of the bar-type supports is connected with the periphery of the vibration film in a perpendicular manner and the other of the bar-type supports is fixed on the support structure.

In an embodiment, the micro-silicon microphone further comprises a capacitance layer separated from the vibration film layer, the surface of the capacitance layer adjacent to the vibration film layer is arranged with spacing bumps, the surface of the capacitance layer away from the vibration film layer is covered with a backplate structure layer and via holes are provided in the capacitance layer and the backplate structure layer.

The present invention further provides a method for fabricating a micro-silicon microphone, comprising: providing a silicon substrate; forming an insulation layer and a vibration film layer sequentially on the top of the silicon substrate, forming the vibration film includes forming a vibration film and vibration beams around the periphery of the vibration film, fixing a first end of the vibration beam on the periphery of the vibration film and a second end of the vibration beam on a support structure.

In an embodiment, the method further includes forming a sacrifice layer, a capacitance layer and a backplate structure layer sequentially on the vibration film layer; forming, on a bottom of the silicon substrate, a back cavity that exposes the insulation layer; forming via holes on the capacitance layer and the backplate structure layer; and removing a part of the insulation layer through the via holes, and removing a part of the sacrifice layer through the back cavity.

In an embodiment, the insulation layer is formed of silicon oxide, the vibration film layer is formed of polycrystalline silicon, the sacrifice layer is formed of silicon oxide, the capacitance layer is formed of polycrystalline silicon and the backplate structure layer is formed of silicon nitride.

In an embodiment, forming the vibration film layer comprises forming distributed vibration beams on a periphery of the vibration film layer.

In an embodiment, forming the sacrifice layer comprises forming central processing blind holes and peripheral processing via holes on a surface of the sacrifice layer.

In an embodiment, forming the capacitance layer comprises forming, on a bottom surface of the capacitance layer combined with the sacrifice layer, spacing bumps with the processing blind holes and connectors connecting the capacitance layer and the vibration film layer with the processing via holes.

In an embodiment, forming via holes in the backplate structure layer comprises forming the via holes in the periphery of the backplate structure layer, the via holes located on the periphery of the backplate structure layer allows the periphery of the capacitance layer to be exposed partially to form pressure welding positions and the method further comprises forming the metal pressure welding points at the pressure welding positions.

The micro-silicon microphone and the fabrication method thereof, provided in the embodiment of the present invention, may overcome the problem of internal stress in a vibration film, restrain occurrence of irregular stress in the vibration film, and hence increasing the sensitivity of the vibration film. Employing a vibration beam in a normal direction or radial direction and allowing the beam to have a bend included can generate a support force that is adaptable to the vibration frequency of the vibration film. Moreover, after IC fabrication process on a silicon substrate is completed, a MEMS fabrication process of a microphone can be completed at a comparatively low temperature, thus ensuring quality of finished products.

### BRIEF DESCRIPTION OF THE DRAWINGS

FIGS. 1-12 are schematic diagrams illustrating steps of fabricating a micro-silicon microphone according to an embodiment of the present invention.

FIG. 13 is a schematic top view illustrating a vibration film layer of a micro-silicon microphone according to an embodiment of the present invention.

FIG. 14 is a schematic top view illustrating a vibration film layer of a micro-silicon microphone according to another embodiment of the present invention.

FIG. 15 is a schematic top view illustrating a vibration film layer of a micro-silicon microphone in a still embodiment of the present invention.

### DETAILED DESCRIPTION

The technical solutions in the embodiments of the present invention will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

A step serial number in the drawing is used merely as a figure mark of the step and does not indicate implementation order.

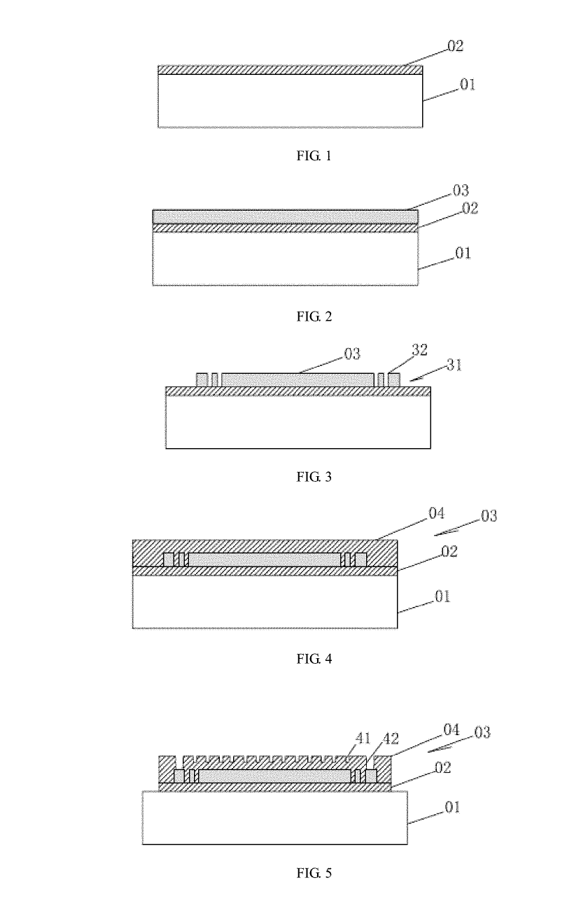

Hereinafter a fabrication method of a micro-silicon microphone according to an embodiment of the present invention will be described with reference to FIGS. 1-12.

As illustrated in FIG. 1, the method comprises a step of forming an insulation layer 02 on a top of a silicon substrate 01.

The insulation layer 02 can be a silicon oxide layer formed with a deposition process. The insulation layer 02 is a support layer for film layers that are formed subsequently.

As illustrated in FIG. 2, the method comprises the step of forming a vibration film layer 03 on the insulation layer 02.

The vibration film layer 03 can be a polycrystalline silicon layer formed with a deposition process.

As illustrated in FIG. 3, the method comprises the step of forming vibration beams 32 on a periphery of the vibration film layer 03.

The vibration film layer 03 is allowed to further form a central vibration part (vibration film) and peripheral fixing parts (vibration beams).

The vibration beams 32 can be formed by processes of photolithography, etching mask, and antistrophic etching, etc.

In a method for fabricating a micro-silicon microphone in another embodiment of the present invention, the vibration film layer 03 forms a boss 31 on the insulation layer 02.

As illustrated in FIG. 4, the method comprises the step of covering the vibration film layer 03 with a sacrifice layer 04.

The sacrifice layer 04 can be a silicon oxide layer formed with a deposition process.

The sacrifice layer 04 is used as a media layer in a capacitance structure of a microphone.

In a method for fabricating a micro-silicon microphone in another embodiment of the present invention, the sacrifice layer 4 covers the periphery of the insulation layer 02 as well.

As illustrated in FIG. 5, the method comprises the step of forming, on a surface of the sacrifice layer 04, central processing blind holes 41 and peripheral processing via holes 42.

The process blind hole 41 can be formed by processes such as photolithography, etching mask and anisotropic etching. The process via holes 42 can be formed by processes such as photolithography and etching to partially etch out the insulation layer 02, so as to allow an end portion of the vibration beam 32 of the vibration film layer 03 to be exposed.

The process via hole 42 is to form a connection point in subsequent processes and inside the process blind hole 41 is to form a part of defined shapes in subsequent processes.

As illustrated in FIG. 6, the method comprises the step of forming a capacitance layer 05 that covers the sacrifice layer 04.

The capacitance layer 05 can be a polycrystalline silicon layer formed with a low-pressure chemical vapor deposition (LPCVD) process.

On the bottom surface of the capacitance layer 05 jointing with the sacrifice layer 04, spacing bumps 51 are formed with the processing blind holes 41, and the spacing bump 51 can ensure avoiding adhesion phenomenon between the vibration film layer 03 and the capacitance layer 05 in application of a finished product, and connectors 53 connecting the capacitance layer 05 and the vibration film layer 03 are formed with the processing via holes 42.

In a method for fabricating a micro-silicon microphone according to another embodiment of the present invention, the capacitance layer 05 covers the periphery of the sacrifice layer 04 as well. As illustrated in FIG. 7, the method comprises the step of forming distributed acoustic via holes 52 in the capacitance layer 05.

The acoustic via holes 52 can be formed by employing processes such as photolithography and etching to allow the sacrifice layer 04 to expose.

A method for fabricating a micro-silicon microphone according to another embodiment of the present invention further comprises exposing the periphery of the insulation layer 02 and the sacrifice layer 04.

As illustrated in FIG. 8, the method comprises the step of forming a backplate structure layer 06 that covers the capacitance layer 05.

The backplate structure layer 06 may be a silicon nitride layer formed with a deposition process.

A method for fabricating a micro-silicon microphone according to another embodiment of the present invention further comprises allowing the backplate structure layer 06 to cover the peripheries of the insulation layer 02, the sacrifice layer 04 and the capacitance layer 05 at the same time.

As illustrate in FIG. 9, the method comprises the step of forming acoustic reception via holes 61 corresponding to the acoustic via holes 52 in the backplate structure layer 06.

The acoustic reception via hole 61 can be formed by processes such as photolithography and etching to constitute acoustic reception channels in connection with the acoustic via holes 52.

As illustrated in FIG. 10, a part of acoustic reception via holes 61 on the periphery of the backplate structure layer 06 allows the periphery of the capacitance layer to be partially exposed to form pressure welding positions, and metal pressure welding points 07 are formed at the pressure welding positions 63.

The pressure welding points 07 can be fabricated by processes such as sputtering, photolithography and etching, etc.

As illustrated in FIG. 11, the method comprises the step of forming a back cavity 08 on a bottom of the silicon substrate 01.

The back cavity 08 may be formed by processes such as dual surface photolithography and deep silicon etching.

The back cavity 08 allows the insulation layer 02 to be exposed.

As illustrated in FIG. 12, the method comprises the step of removing the insulation layer 02 and the sacrifice layer 04 within the range surrounded by the vibration beams 32 and within the projection range of the capacitance layer 05.

Processes such as wet etching may be employed to remove the insulation layer 02 and the sacrifice layer 04 from the direction of back cavity 08 and the acoustic via hole 52 respectively or together.

The central part 03 of the vibration film layer 03, after the insulation layer 02 and the sacrifice layer 04 are partially removing, is suspended as a movable structure and the periphery part of the vibration film layer 03 is connected, via the vibration beams 32, to the retained insulation layer 02 and sacrifice layer 04 that are supported by the silicon substrate 01 and the backplate structure layer 06.

On the basis of the method for fabricating a micro-silicon microphone according to the above embodiment, the sequence of forming the vibration film layer 03 and the capacitance layer 05 can be exchanged and hence their position will be exchanged accordingly, which will not have adverse influences on quality of finished products.

FIG. 12 is a schematic diagram illustrating sectional structure of a micro-silicon microphone according to an embodiment of the present invention as well. As illustrated in FIG. 12, the micro-silicon microphone comprises a silicon substrate 01, a vibration film layer 03 and a capacitance layer 05 on the top of the silicon substrate 01 and supported by insulation material. A cavity is formed between the vibration film layer 03 and the capacitance layer 05, and a back cavity 08 is formed on the bottom of the silicon substrate 01 to expose the vibration film layer 03.

A surface of the capacitance layer 05 adjacent to the vibration film layer 03 is arranged with spacing bumps 51, and a surface of the capacitance layer 05 away from the vibration film layer 03 is covered with backplate structure layer 06, and via holes (acoustic via holes 52 and acoustic reception via holes 61 that are in communication with each other) are provided in the capacitance layer 05 and the backplate structure layer 05. The capacitance layer 05 and the vibration film layer 03 forms a capacitance structure.

See the FIG. 12, the vibration film layer 03 comprises a central vibration film 33 and peripherally distributed vibration beams 32.

A cavity space that is sufficient for vibration of a vibration film layer 03 is formed on both sides of the vibration film layer 03 in the present embodiment and the stress accumulation of the vibration film 33 is hence dispersed by the vibration beams 32, allowing the sensitivity of the vibration film 33 to be increased. In addition, accidental adhesion of the vibration film 33 with a capacitance layer 05 in a vibration process can be avoided by the spacing bumps 51.

A vibration film layer 03 of a micro-silicon microphone according to an embodiment of the present invention comprises vibration beams 32 and a vibration film 33 that is located on a same plane with the vibration beams 32. The vibration beams 32 are uniformly distributed around the periphery of the vibration film 33, with one end of the vibration beam 32 being fixed to the periphery of the vibration film 33 and the other end being fixed to a support structure (for example, the support structure can be the insulation layer 02 and the sacrifice layer 04 as illustrated in FIG. 12).

A vibration beam of a micro-silicon microphone according to another embodiment of the present invention comprises a bend which allows force-bearing directions of the two beam bodies at the bend position of the vibration beam 32 to be different so as to effectively change the elasticity of the vibration beam 32 as a whole and produce effective support force that is adaptable to the vibration film 33 upon vibration at high and low frequency. For example, one or a plurality of bends in order or in symmetry may be comprised. For example, the vibration beam 32 may be a L-type bend. For example, the L-type bend can be formed of two crossed bar-type supports, one of the bar-type supports is connected with the periphery of the vibration beam 33 in a perpendicular manner and the other of the bar-type supports is fixed at the support structure. Besides, the bend may be in an interval or continual arrangement.

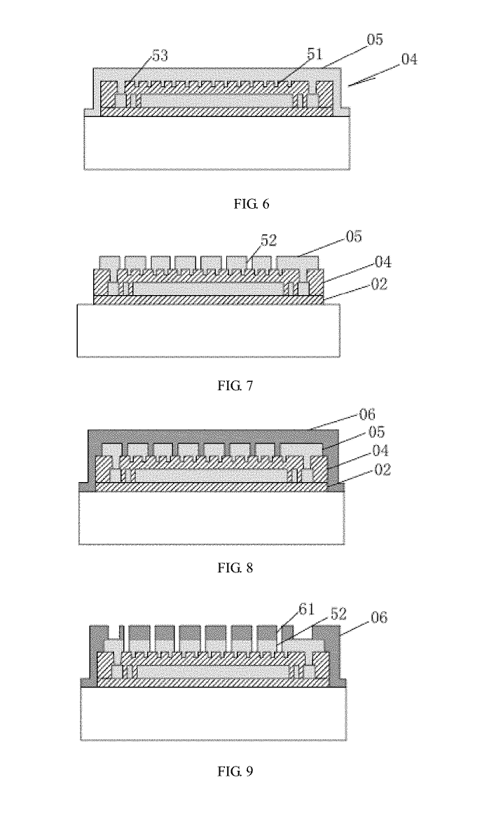

FIG. 13 is a schematic diagram illustrating structure of a vibration film layer of a micro-silicon microphone according to an embodiment of the present invention. As illustrated in FIG. 13, the vibration film layer 03 comprises a circular-shaped vibration film 33, a first vibration beam 34 and a second vibration beam 35 mirroring the first vibration beam 34. The first vibration beam 34 and the second vibration beam 35 forms a group and are uniformly arranged around the periphery (circumferential direction) of the vibration film 33. For example, the first vibration beam 34 and the second vibration beam 35 constituent a group, such that a plurality of the groups are distributed around the periphery of the vibration film 33. For example, two adjacent vibration beam groups forms an included angle of 20-60 degree with respect to the center of the circular-shaped vibration film 33. The structural stability of the vibration film layer 03 can be further improved by arranging the vibration beams 32 in groups and adjusting the distribution angle of the vibration beams 32 with respect to the vibration film 33.

The first vibration beam 34 comprises two crossed bar-type supports (i.e., two sections of a beam body) and is a L-type bend, one of the bar-type supports is connected with the periphery of the vibration beam 33 in a perpendicular manner (i.e., in radial direction or normal direction), and the other of the bar-type supports is fixed on a support structure.

In the vibration film layer of the present embodiment, a first vibration beam 34 and a second vibration beam 35 provided in group are uniformly arranged around the periphery of the vibration film 33, hence ensuring support force in radial direction when the vibration film 33 vibrates.

The dispersed connection support structure formed by the first vibration beam 34 and the second vibration beam 35 can effectively disperse the internal stress of the vibration film 33, so as to avoid premature damage of the vibration film 33 in high-frequency vibration.

An mirroring arrangement of the first vibration beam 34 and the second vibration beam 35 improves stability of support torque in a same radial direction and eliminates support torque differences in respective directions of the vibration film 33 when vibrating at high sound pressure and high frequency, therefore restraining irregular stress that occurs to the vibration film 33 to avoid reducing the sensitivity of the vibration film 33.

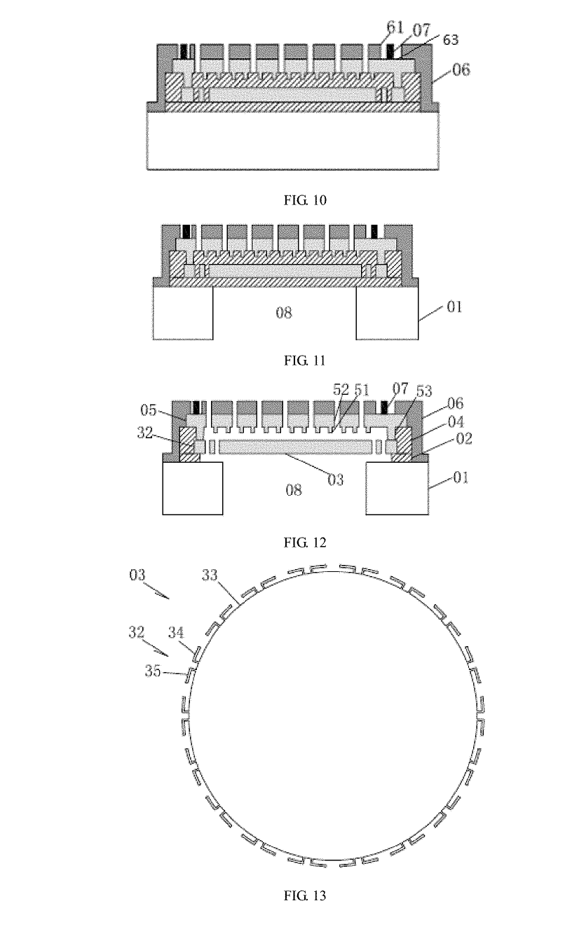

FIG. 14 is a schematic diagram illustrating structure of a vibration film layer of a micro-silicon microphone according to another embodiment of the present invention. As illustrated in FIG. 14, the vibration film layer 03 comprises a circular-shaped vibration film 33 and four vibration beams 32 located on a same plane with the circular-shaped vibration film 33 and the vibration beams 32 are fixed around the vibration film 33 with an interval of 90 degree.

The vibration beam 32 is a bar-typed support, one end of which is connected with the periphery of the vibration film 33 in a perpendicular manner (i.e., in a radial direction or normal direction), and is extended into the periphery of the vibration film 33 and smoothly connected with a surface of the vibration film 33, and the other end of which is fixed on a support structure.

In the vibration film layer according to the present embodiment, a support connection structure of a vibration beam 32 with respect to a vibration film 33 is optimized such that occurrence of connection stress at an support connection position of the vibration beam 32 and the vibration film 33 can be avoided, therefore ensuring adaptability of the vibration film layer 03 in a particular frequency range under comparatively large sound pressure.

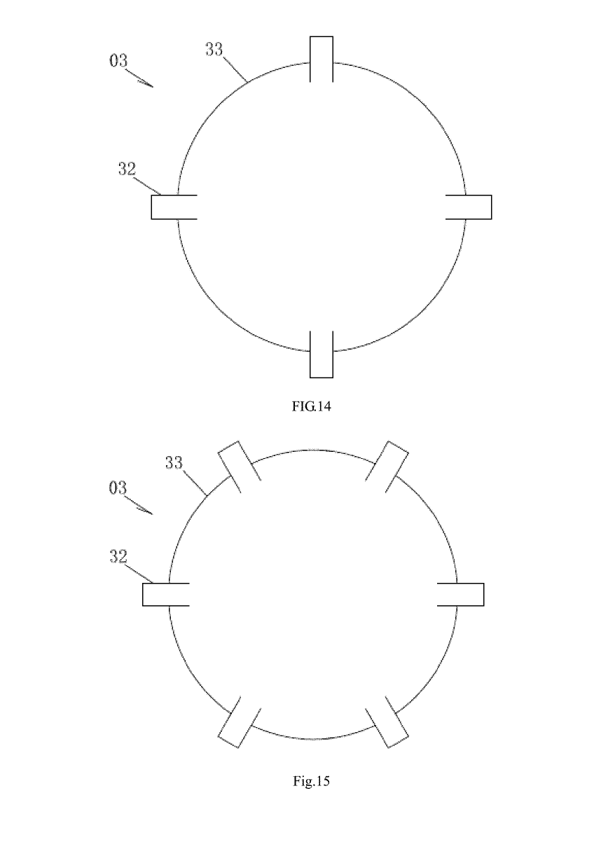

FIG. 15 is a schematic diagram illustrating structure of a vibration film layer of a micro-silicon microphone according to a further embodiment of the present invention. As illustrated in FIG. 15, on the basis of the above embodiments, this embodiment comprises six vibration beams 32 fixed around the outline of the vibration film 33 with an interval of 60 degree.

In the vibration film layer of the present embodiment, a support connection structure of a vibration beam 32 with respect to a vibration film 33 is optimized such that occurrence of connection stress at an support connection position of the vibration beam 32 and the vibration film 33 can be avoided, thus ensuring adaptability of the vibration film layer 03 in a particular frequency range under comparatively large sound pressure.

In a micro-silicon microphone of another embodiment in the present invention, on the basis of the above embodiment, the outline of the vibration film 33 is limited by a tailored shape, and may be a circular shape, a square shape or other polygons.

What is described is merely preferable embodiments of the present invention and by no means limitative to the present invention, any corrections or equivalent replacement etc., within the spirit and scope of the present invention, should be covered in the protective scope of the present invention.

1. A micro-silicon microphone, comprising:
a silicon substrate; and
an insulation layer and a vibration film layer sequentially disposed on the silicon substrate,
wherein the vibration film comprises vibration beams and a vibration film, the vibration beams are uniformly arranged around a periphery of the vibration film, a first end of the vibration beam is fixed on the periphery of the vibration film and a second end of the vibration beam is fixed on a support structure.

2. The micro-silicon microphone according to claim 1, wherein the vibration beam is connected with the periphery of the vibration film in a perpendicular manner, the first end of the vibration beam extends into the periphery of the vibration film and is smoothly connected with a surface of the vibration film.

3. The micro-silicon microphone according to claim 1, wherein the vibration beam comprises a first vibration beam and a second vibration beam mirroring the first vibration.

4. The micro-silicon microphone according to claim 3, wherein the first vibration beam has an L-shaped bend formed of two crossed bar-type supports, one of the bar-type supports is connected with the periphery of the vibration film in a perpendicular manner and the other of the bar-type supports is fixed on the support structure.

5. The micro-silicon microphone according to claim 1, wherein the vibration beam comprises a bend.

6. The micro-silicon microphone according to claim 5, wherein the vibration beam has an L-shaped bend formed of two crossed bar-type supports, one of the bar-type supports is connected with the periphery of the vibration film in a perpendicular manner and the other of the bar-type supports is fixed on the support structure.

7. The micro-silicon microphone according to claim 1, further comprising a capacitance layer separated from the vibration film layer.

8. The micro-silicon microphone according to claim 7, wherein a surface of the capacitance layer adjacent to the vibration film layer is provided with spacing bumps, and a surface of the capacitance layer away from the vibration film layer is covered with a backplate structure layer.

9. The micro-silicon microphone according to claim 8, wherein via holes are provided in the capacitance layer and the backplate structure layer.

10. A method for fabricating a micro-silicon microphone, comprising:
providing a silicon substrate; and
forming an insulation layer and a vibration film layer sequentially on a top of the silicon substrate,
wherein forming the vibration film layer comprises forming a vibration film and vibration beams around a periphery of the vibration film, fixing a first end of the vibration beam on the periphery of the vibration beam, and fixing a second end of the vibration beam on a support structure.

11. The method according to claim 10, further comprising:
forming a sacrifice layer, a capacitance layer and a backplate structure layer sequentially on the vibration film layer;
forming a back cavity that exposes the insulation layer on a bottom of the silicon substrate;
forming via holes in the capacitance layer and the backplate structure layer; and
removing a part of the insulation layer through the back cavity, and removing a part of the sacrifice layer through the via holes.

12. The method according to claim 11, wherein the insulation layer is formed of silicon oxide, the vibration film layer is formed of polycrystalline silicon, the sacrifice layer is formed of silicon oxide, the capacitance layer is formed of polycrystalline silicon and the backplate structure layer is formed of silicon nitride.

13. The method according to claim 11, wherein forming the sacrifice layer comprises forming central processing blind holes and peripheral processing via holes on a surface of the sacrifice layer.

14. The method according to claim 13, wherein forming the capacitance layer comprises forming, on a bottom surface of the capacitance layer combined with the sacrifice layer, spacing bumps with the processing blind holes, and forming connectors connecting the capacitance layer and the vibration film layer with the processing via holes.

15. The method according to claim 11, wherein forming the via holes in the backplate structure layer comprises forming via holes on a periphery of the backplate structure layer, the via holes at the periphery of the backplate structure layer making the periphery of the capacitance layer partially exposed to form pressure welding positions, and
wherein the method further comprises forming metal pressure welding points at the welding positions.
